(19) United States
(12) Patent Application Publication
(10) Pub. No.: US 2013/0231474 A1
(43) Pub. Date: Sep. 5, 2013

(54) POLYSACCHARIDE DERIVATIVES INCLUDING AN ALKENE UNIT AND THIOL-CLICK CHEMICAL COUPLING REACTION

(71) Applicants: Rachel Auzely, Le Gua (Les Saillants) (FR); Jimmy Mergy, Aoste (FR); Eric Bayma-Pecit, Saint -Honore (FR)

(72) Inventors: Rachel Auzely, Le Gua (Les Saillants) (FR); Jimmy Mergy, Aoste (FR); Eric Bayma-Pecit, Saint -Honore (FR)

(73) Assignee: UNIVERSITE JOSEPH FOURIER - GRENOBLE 1, St-Martin-d'Hères (FR)

(21) Appl. No.: 13/988,053

(22) PCT Filed: Nov. 18, 2011
(86) PCT No.: PCT/EP2011/070483

§ 371 Date: May 17, 2013

(30) Foreign Application Priority Data
Nov. 18, 2010 (FR) 1059465

(51) Int. Cl. C08B 37/08; C08B 37/02

(52) U.S. Cl. CPC C08B 37/0072; C08B 37/0021
USPC 536/55.1; 536/112

(57) ABSTRACT

The invention relates to polysaccharides grafted with a unit including a carbon-carbon double bond, to polysaccharides grafted with a unit including a carbon-carbon double bond functionalized by a thioether unit, to the methods for preparing said compounds, to the compositions including such compounds and to the materials including such materials or compositions.

The present invention relates to the field of grafted and optionally functionalized polysaccharides, to methods for obtaining same and to materials including such polysaccharides. The invention may allow to obtain new types of materials, such as hydrogels, with numerous applications in the fields of biology, medicine, pharmaceuticals and cosmetics.

Biomaterials engineering has in the past 15 years seen significant advances, notably related to the emergence of new applications in the fields of vectorization and tissue repair.

The effectiveness of these materials, for example intended to carry a drug toward a target organ or to restore tissue, rests notably on their ability to communicate with their environment.

This effectiveness can be related to several parameters, including the chemical nature and the mechanical properties of the materials as well as their ability to respond to external stimuli (pH, temperature, presence of biomolecules), by analogy with living systems.

Among the polymers used to produce such systems, polysaccharides (PS) of natural origin are candidates of choice. They generally have satisfactory biocompatibility and biodegradability properties and can further exhibit biological activity.

Their chemical complexity provides multiple options in terms of structure and/or properties, and their natural origin can make them particularly attractive from an environmental, toxicological and/or commercial perspective.

It is thus particularly desirable to obtain new modified polymers of natural origin, such as modified polysaccharides, notably in order to obtain compounds with new or improved properties, for example thickeners, gelling agents or dispersants.

These modified polymers or derivatives of these polymers can in addition be of a great use in the cosmetics, pharmaceuticals or biomedical fields.

It is for all of these reasons that numerous grafted and/or functionalized polysaccharide syntheses are described in the literature.

For example, the international application WO 2009/063082 describes the cycloaddition reaction (so-called Huisgen reaction), between a polysaccharide entity (guar) functionalized by alkyne groups and a polyether bearing azide functional groups, in the presence of a Copper I catalyst. This reaction makes it possible to form, in a regioselective manner, essentially 1-4-disubstituted 1,2,3-triazole.

The ease of implementation and the compatibility of this reaction with other chemical functionalities including, among others, those of sugars and of proteins, earned it the name “click chemistry” (M. Meldal et al., Chem. Rev. (2008), 108, 2952).

This cycloaddition reaction was also used by Crescenzi et al., WO 2008/031525, to prepare hyaluronic acid-based three-dimensional networks.

More particularly, it uses a pair of polysaccharides of which one or both are hyaluronic acid. The polysaccharide (PS) and the hyaluronic acid each carry reactive units with, for example, a terminal azide or alkyne group, leading via a 1,3-dipolar cycloaddition mechanism to the formation of three-dimensional networks.

However, this click-chemistry reaction can be unsatisfactory in certain aspects, for example in terms of toxicity and/or ease of implementation, in particular due to the elimination of Cu(I), which is toxic in vivo.

The document EP 1 564 220 describes methods for chemically crosslinking hyaluronic acid as well as for coupling groups of interest on hyaluronic acid. A hydrazyl or amino group is introduced on a hyaluronic acid polymer by converting a carboxyl group of the hyaluronic acid into an amide group or N-substituted ester. Then, the hyaluronic acid thus obtained is derived with a mercapto group or a group including an unsaturated bond. This reaction can occur spontaneously in water but it is relatively slow (several hours) and nonquantitative. The reaction can be activated in the presence of radicals to improve the yield, but polymerization will occur and a crosslinked gel will be obtained. This reaction does not make it possible to obtain a polymer, notably a linear hyaluronic acid, and the graft ratio is not controlled.

Thus, even if numerous syntheses of grafted and/or functionalized polysaccharide have been described in the literature, they are not satisfactory in terms of graft type and/or functionalization obtained, yield, ease of implementation, safety, notably of the solvents and/or reagent used, cost, ecology, polyvalence and/or effectiveness.

Furthermore, the modified polysaccharides described can prove unsatisfactory in terms of functionality, cost, purity, reactivity and/or use.

There thus remains a need for a simple, effective and selective method for grafting active molecules on polysaccharides and/or for their chemical crosslinking in an aqueous or hydro-organic medium.

The present invention specifically proposes a new method for functionalizing polysaccharides, notably by active molecules, or for their crosslinking, which makes it possible to solve all or part of the problems mentioned above.

The present invention also provides new polysaccharide derivatives bearing reactive units that can be obtained easily and economically on an industrial scale.

Another objective of the invention is to effectively and selectively functionalize a polysaccharide bearing reactive units by molecules or macromolecules, notably active and varied, and/or to chemically crosslink it.

The present invention also aims to carry out these two reaction steps under conditions that are gentle and/or that affect the molar mass of the PS and the molecules to be grafted little or not at all.

Finally, the invention also aims to provide biomaterials containing modified polysaccharides in the form of grafted linear polymers or hydrogels for biomedical, pharmaceutical or cosmetic applications.

The methods of the present invention include the grafting of an unconjugated alkene on a hydroxyl or amine functional group of a polysaccharide and in particular a hyaluronic acid. This reaction is a controlled reaction, including in the presence of radicals, making it possible to obtain very good yields. Moreover, the graft ratio or the degree of substitution (DS) can be controlled by varying the quantity of reagent.

After the grafting of the unconjugated alkene on the polysaccharide, it is possible to functionalize this polysaccharide with a wide variety of groups including a thiol functional group by coupling via thiol-click chemistry. Advantageously, it is notably possible to functionalize polysaccharides, in particular hyaluronic acid, with hydrophobic groups or any other group of interest.

By reacting the polysaccharide bearing the unconjugated alkene, notably hyaluronic acid, with compounds including a plurality of thiol functional groups, it is possible to obtain a controlled crosslinking of the polysaccharide. This makes it possible notably to obtain crosslinked hyaluronic acid hydrogels.

Of course, it is possible to combine the functionalization and the crosslinking of the polysaccharide according to the methods of the invention.

In particular, the invention relates to crosslinked hyaluronic acid hydrogels functionalized with various groups of interests by thiol-click chemistry.

The present invention thus aims to solve the problems mentioned above in whole or part.

### SUMMARY

The invention relates to a method for preparing a polysaccharide having at least one alkene unit grafted on a hydroxyl or amine functional group of said polysaccharide, said alkene unit corresponding to the following formula A′:

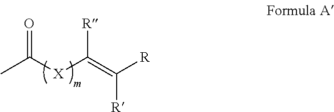

wherein
m is an integer between 1 and 10,
X is a CR₁R₂ unit, wherein R₁ and R₂ are each independently a hydrogen atom, a halogen atom, a linear, branched or cyclic alkylene group having from 1 to 6 carbon atoms, an aryl group, or an arylalkyl group, notably benzyl, and
R, R′ and R″ are each independently a hydrogen atom, a halogen atom, a linear, branched or cyclic alkyl radical having from 1 to 6 carbon atoms, an aryl group, or an arylalkyl group, in particular R, R′ and R″ are each a hydrogen atom,
comprising the following steps:
a) reacting an acid anhydride of the following Formula A:

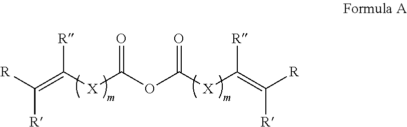

wherein:
m is an integer between 1 and 10,
X is a CR₁R₂ unit, wherein R₁ and R₂ are each independently a hydrogen atom, a halogen atom, a linear, branched or cyclic alkylene group having from 1 to 6 carbon atoms, an aryl group, or an arylalkyl group, notably benzyl, and
R, R′ and R″ are each independently a hydrogen atom, a halogen atom, a linear, branched or cyclic alkyl radical having from 1 to 6 carbon atoms, an aryl group, or an arylalkyl group, with at least one polysaccharide,
in a hydro-organic solvent comprised of water and a polar aprotic solvent or a polar protic solvent,
b) recovering the polysaccharide including a grafted alkene unit.

In the methods of the invention, step a) can be carried out in a solvent comprised of water and/or a polar aprotic solvent, said polar aprotic solvent being selected from DMF and DMSO.

In the methods of the invention, step a) is preferably carried out in a water/DMF, water/DMSO or water/isopropanol mixture.

In the methods of the invention, step a) is preferably carried out in a water/DMF or water/DMSO mixture, notably at a volume ratio from 5/1 to 1/2, and in particular from 3/2 to 1/1.

In the methods of the invention, step a) is preferably carried out at a pH between 6 and 11, notably between 7 and 10 and in particular between 8 and 9.

In the methods of the invention, in step a) the molar graft ratio is preferably modulated by the quantity of anhydride added.

Preferably, the polysaccharide is selected from poly(galacturonate)s, heparin and derivatives thereof, hyaluronic acid and derivatives thereof, chondroitin sulfates, pectin and derivatives thereof, alginates, and neutral polysaccharides such as cellulose, dextran, pullulan, starch, maltodextrin and derivatives thereof, chitin, chitosan and derivatives thereof.

The invention also relates to polysaccharides having at least one alkene unit grafted on a hydroxyl or amine functional group of said polysaccharide, said unit corresponding to the following Formula A′:

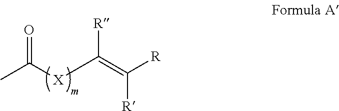

wherein
m is an integer between 1 and 10,
X is a CR₁R₂ unit, wherein R₁ and R₂ are each independently a hydrogen atom, a halogen atom, a linear, branched or cyclic alkylene group having from 1 to 6 carbon atoms, an aryl group, or an arylalkyl group, notably benzyl, and
R, R′ and R″ are each independently a hydrogen atom, a halogen atom, a linear, branched or cyclic alkyl radical having from 1 to 6 carbon atoms, an aryl group, or an arylalkyl group, in particular R, R′ and R″ are each a hydrogen atom.

Preferably, the polysaccharide has a molar graft ratio between 0.5 and (number of free hydroxyl functional groups per polysaccharide repeating unit) 100% per polysaccharide repeating unit.

Preferably, the polysaccharide is selected from poly(galacturonate)s, heparin and derivatives thereof, hyaluronic acid and derivatives thereof, chondroitin sulfates, pectin and derivatives thereof, alginates, and neutral polysaccharides such as cellulose, dextran, pullulan, starch, maltodextrin and derivatives thereof, chitin, chitosan and derivatives thereof.

In a preferred embodiment, the polysaccharide is the hyaluronic acid corresponding to Formula B:

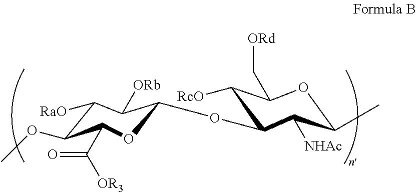

wherein
n′ is between 10 and 10,000 and in particular between 15 and 7,000,

### R₃ is H or Na,

Ra, Rb, Rc and Rd are each independently H or a unit of Formula A′ as defined above.

The invention also relates to a method for preparing a polysaccharide functionalized by at least one thioether unit grafted on a hydroxyl or amine functional group of said polysaccharide, said unit corresponding to the following Formula C:

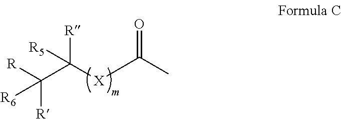

wherein
m is an integer between 1 and 10,
X is a CR₁R₂ unit, wherein R₁ and R₂ are each independently a hydrogen atom, a halogen atom, a linear, branched or cyclic alkylene group having from 1 to 6 carbon atoms, an aryl group, or an arylalkyl group,
R and R′ are each independently a hydrogen atom, a halogen atom, a linear, branched or cyclic alkyl radical having from 1 to 6 carbon atoms, an aryl group, or an arylalkyl group, in particular R and/or R′ is a hydrogen atom,
R₅ or R₆ is a hydrogen atom and the other is Rₜₕᵢₒ—S—, Rₜₕᵢₒ being a group having at least 1 carbon atom, comprising the following steps:
a) preparing a polysaccharide having at least one alkene unit grafted on at least one hydroxyl or amine functional group of said polysaccharide of the preparation method described above,
b) reacting a thiol compound, Rₜₕᵢₒ—SH, via a radical reaction with the polysaccharide obtained in the preceding step,
c) recovering the functionalized polysaccharide.

Preferably, the radical reaction of step b) is
photoinitiated, notably by 4-(2-hydroxyethoxy)phenyl-(2-hydroxy-2-propyl)ketone, or
initiated by a water soluble initiator, without UV light, such as azobis-(2-methylpropionamidine)dihydrochloride, or 2,2′-azobis[2(2-imidazolin-2-yl)propane]dihydrochloride.

In the methods of the invention, step b) is carried out preferably in a solvent selected from water or a water/ethanol, water/isopropanol, water/DMF or water/DMSO mixture.

Preferably, the polysaccharide used in the methods of the invention is selected from poly(galacturonate)s, heparin and derivatives thereof, hyaluronic acid and derivatives thereof, chondroitin sulfates, pectin and derivatives thereof, alginates, and neutral polysaccharides such as cellulose, dextran, pullulan, starch, maltodextrin and derivatives thereof, chitin, chitosan and derivatives thereof.

The invention also relates to a polysaccharide functionalized by at least one thioether unit grafted on a hydroxyl or amine functional group of said polysaccharide, said unit corresponding to the following Formula C:

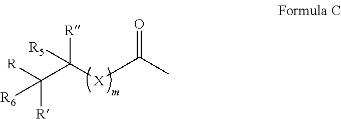

wherein
m is an integer between 1 and 10,
X is a CR₁R₂ unit, wherein R₁ and R₂ are each independently a hydrogen atom, a halogen atom, a linear, branched or cyclic alkylene group having from 1 to 6 carbon atoms, an aryl group, or an arylalkyl group,
R and R′ are each independently a hydrogen atom, a halogen atom, a linear, branched or cyclic alkyl radical including from 1 to 6 carbon atoms, an aryl group, or an arylalkyl group, in particular R and/or R′ is a hydrogen atom,
R₅ or R₆ is a hydrogen atom and the other is Rₜₕᵢₒ—S—, Rₜₕᵢₒ being a group having at least 1 carbon atom.

Preferably, the polysaccharides of the invention have a graft ratio in thioether units of Formula C between 0.5 and (number of free hydroxyl functional groups per polysaccharide repeating unit) 100% per polysaccharide repeating unit.

Preferably, the Rₜₕᵢₒ—S— comes from compounds selected from:
alkyl thiols, notably linear, branched or cyclic alkyls, for example pentanethiol or decanethiol,
aryl thiols, notably heteroaryls, having for example a nitrogen and/or sulfur atom,
synthetic polymers, belonging notably to the family of polyethers, such as poly(ethylene glycol)s, bearing at least one thiol functional group, Pluronics bearing at least one thiol functional group, to the family of poly(N-alkylacrylamide)s (poly(N-isopropylacrylamide)) bearing at least one thiol functional group,
mono-, oligo- or polysaccharides bearing at least one thiol functional group, for example at the reducing end or along the oligo- or polysaccharide chain,
peptides bearing at least one thiol functional group,
oligonucleotides bearing at least one thiol functional group, and
active compounds, notably pharmaceutically active compounds, bearing at least one thiol functional group,
steroids,
cyclodextrins,
compounds having at least two thiol functional groups, notably two, three, four, five or six thiol functional groups, and
poly(ethylene glycol)s, in particular with at least one thiol functional group at the chain end.

Preferably, the polysaccharide is selected from poly(galacturonate)s, heparin and derivatives thereof, hyaluronic acid and derivatives thereof, chondroitin sulfates, pectin and derivatives thereof, alginates, and neutral polysaccharides such as cellulose, dextran, pullulan, starch, maltodextrin and derivatives thereof, chitin, chitosan and derivatives thereof.

In a preferred embodiment, the polysaccharide is the hyaluronic acid corresponding to Formula D:

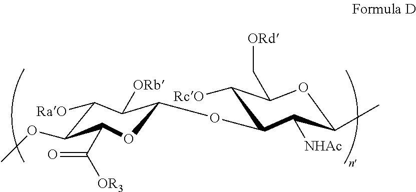

wherein
n′ is between 10 and 10,000, and in particular between 15 and 7,000,
R₃ is H or Na, and
Ra′, Rb′, Rc′ and Rd′ are each independently H or a unit of Formula C as defined above.

The invention also relates to a method for crosslinking hyaluronic acid comprising the following steps:
a) preparing a hyaluronic acid having at least one alkene unit grafted on at least one hydroxyl functional group of said hyaluronic acid of the preparation method described above,
b) reacting a compound including several thiol functional groups with the hyaluronic acid obtained in the preceding step,
c) recovering the crosslinked polysaccharide.

Preferably, the compound including several thiol functional groups is selected from poly(ethylene glycol)dithiol and poly(ethylene)tetrathiol.

Preferably, step b) includes irradiation with UV light.

In preferred embodiments, the HA crosslinking methods further include the hydration of hyaluronic acid to form a hydrogel.

The invention also relates to the crosslinked hyaluronic acid that can be obtained by a method of the invention and a hyaluronic acid hydrogel that can be obtained by a method of the invention.

The present invention also relates to a method for preparing crosslinked hyaluronic acid functionalized by at least one thioether unit comprising the preparation of a hyaluronic acid functionalized by a preparation method of the invention and the crosslinking of the hyaluronic acid of the invention.

The invention also relates to a functionalized crosslinked hyaluronic acid that can be obtained by a method of the invention as well as a controlled-release pharmaceutical or cosmetic composition comprising one such functionalized crosslinked hyaluronic acid or a polysaccharide of the invention or a hyaluronic acid hydrogel of the invention.

According to a first aspect, the invention relates to a method for preparing a polysaccharide, in particular a hyaluronic acid, grafted with a unit including a carbon-carbon double bond.

According to a second aspect, the invention relates to a polysaccharide, in particular a hyaluronic acid, grafted with a unit including a carbon-carbon double bond.

According to a third aspect, the invention relates to a method for preparing a polysaccharide, in particular a hyaluronic acid, grafted with a unit including a carbon-carbon double bond functionalized by a thioether unit.

According to a fourth aspect, the invention relates to a polysaccharide, in particular a hyaluronic acid, grafted with a unit including a carbon-carbon double bond functionalized by a thioether unit.

According to a fifth aspect, the invention relates to a composition comprising a polysaccharide grafted with a unit including a carbon-carbon double bond and/or a polysaccharide grafted with a unit including a carbon-carbon double bond functionalized by a thioether unit.

According to a sixth aspect, the invention relates to a material comprising at least one polysaccharide grafted with a unit including a carbon-carbon double bond, at least one polysaccharide grafted with a unit including a carbon-carbon double bond functionalized by a thioether unit, at least one composition comprising a polysaccharide grafted with a unit comprising at least one carbon-carbon double bond and/or a polysaccharide grafted with a unit including a carbon-carbon double bond functionalized by a thioether unit.

### DETAILED DESCRIPTION OF THE INVENTION

In the present description, the expression “unit including a carbon-carbon double bond” is equivalent to the expression “alkene unit”, the expression “grafted by a unit including a carbon-carbon double bond” is equivalent to the expression “grafted alkene”, the expression “unit including a carbon-carbon double bond functionalized by a thioether unit” is equivalent to the expression “thioether grafted alkene unit” and the expression “grafted by a unit including a carbon-carbon double bond functionalized by a thioether unit” is equivalent to the expression “thioether functionalized grafted alkene” or “functionalized by a thioether unit”.

The invention relates to a method for preparing a polysaccharide having at least one alkene unit grafted on a hydroxyl or amine functional group of said polysaccharide, said alkene unit corresponding to the following Formula A′:

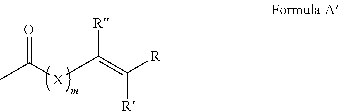

wherein
m is an integer between 1 and 10,
X is a CR₁R₂ unit, wherein R₁ and R₂ are each independently a hydrogen atom, a halogen atom, a linear, branched or cyclic alkylene group having from 1 to 6 carbon atoms, an aryl group, or an arylalkyl group, notably benzyl, and
R, R′ and R″ are each independently a hydrogen atom, a halogen atom, a linear, branched or cyclic alkyl radical having from 1 to 6 carbon atoms, an aryl group, or an arylalkyl group, in particular R, R′ and R″ are each a hydrogen atom,
comprising the following steps:
a) reacting an acid anhydride of following Formula A:

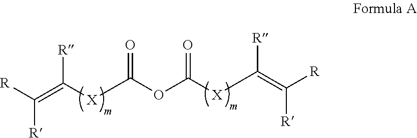

wherein:
m is an integer between 1 and 10,
X is a CR₁R₂ unit, wherein R₁ and R₂ are each independently a hydrogen atom, a halogen atom, a linear, branched or cyclic alkylene group having from 1 to 6 carbon atoms, an aryl group, or an arylalkyl group, notably benzyl, and
R, R′ and R″ are each independently a hydrogen atom, a halogen atom, a linear, branched or cyclic alkyl radical having from 1 to 6 carbon atoms, an aryl group, or an arylalkyl group, with at least one polysaccharide,
in a hydro-organic solvent comprised of water and a polar aprotic solvent or a polar protic solvent,
b) recovering the polysaccharide including a grafted alkene unit.

According to a first aspect, the invention relates to a method for preparing polysaccharide, also called PS, grafted with a unit having at least one carbon-carbon double bond, comprising at least the following steps consisting of:
a) reacting an acid anhydride of the following Formula A:

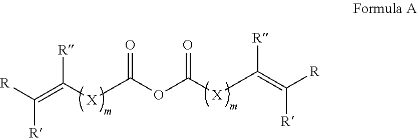

wherein:
   m is an integer between 1 and 10,
   X is a CR₁R₂ unit, wherein R₁ and R₂ are each independently a hydrogen atom, a halogen atom, a linear, branched or cyclic alkylene group having from 1 to 6 carbon atoms, an optionally substituted aryl group, or an arylalkyl group, notably benzyl, and
   R, R′ and R″ are each independently a hydrogen atom, a halogen atom, a linear, branched or cyclic alkyl radical having from 1 to 6 carbon atoms, an optionally substituted aryl group, or an arylalkyl group, notably benzyl,
with at least one polysaccharide, in a solvent including, or consisting of: water and/or a polar aprotic solvent, in particular said polar aprotic solvent is selected from DMF and DMSO, and
b) recovering the polysaccharide grafted with a unit having at least one carbon-carbon double bond.

In the methods of the invention, the acid anhydride can be replaced with an acid chloride or a corresponding mixed anhydride.

Said acid chloride can correspond to the following Formula a:

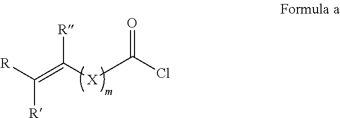

wherein R, R′, R″, X and m are as defined for the anhydride of Formula A.

Said mixed anhydride can correspond to the following Formula a′:

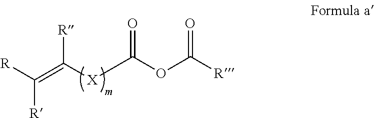

wherein

R″ is a linear, branched or cyclic alkyl including from 1 to 6 carbon atoms, in particular selected from methyl, ethyl, propyl, butyl, pentyl and hexyl, and

R, R′, R″, X and m are as defined for the anhydride of Formula A.

The acid anhydride can correspond to Formula A wherein m is an integer between 2 and 6, in particular 4 or 5.

The acid anhydride can correspond to Formula A wherein X is CH₂.

The acid anhydride can correspond to Formula A wherein R, R′ and R″ are each a hydrogen atom.

According to a particular embodiment, the acid anhydride corresponds to Formula A wherein:
m is an integer between 2 and 6, in particular 4 or 5,
X is CH₂, and
R, R′ and R″ are each a hydrogen atom.

The anhydride can react in particular with the polysaccharide on alcohol functional groups (hydroxyls) and/or amine functional groups, preferably on primary amine functional groups. Thus, the unit having at least one carbon-carbon double bond (alkene unit) can be linked to the polysaccharide by an ester or amide bond.

In the methods of the invention, step a) can be carried out in a solvent comprised of water and/or a polar aprotic solvent, said polar aprotic solvent being selected from DMF and DMSO.

In the methods of the invention, step a) is preferably carried out in a water/DMF, water/DMSO or water/isopropanol mixture.

In particular, step a) is carried out in a water/isopropanol mixture at a volume ratio from 5/1 to 1/2, preferably from 3/2 to 1/1 and more preferentially at a volume ratio of 3/2.

In particular, step a) is carried out in a water/DMF or water/DMSO mixture, notably at a volume ratio from 5/1 to 1/2, preferably from 3/2 to 1/1 and more preferentially at a volume ratio of 3/2.

The reaction of step a) can be carried out at a pH between 6 and 11, notably between 7 and 10 and in particular between 8 and 9.

The reaction of step a) can be carried out at a temperature between 0 and 50° C., notably about 4 to 20° C.

The molar graft ratio can be between 0.5 and (number of free hydroxyl functional groups per polysaccharide repeating unit)×100%, in particular between 0.5 and 400%, notably between 2 and 250%, in particular between 5 and 100%, particularly between 7 and 75%, even between 7 and 50% per polysaccharide repeating unit.

In particular the maximum molar graft ratio is the number of free hydroxyl functional groups per polysaccharide repeating unit ×100.

The molar graft ratio is derived from the number of moles of grafting unit per mole of polysaccharide repeating unit.

In the methods of the invention, in step a) the molar graft ratio is preferably modulated by the quantity of anhydride added.

The polysaccharide can be selected from poly(galacturonate)s, heparin and derivatives thereof, hyaluronic acid and derivatives thereof, chondroitin sulfates, pectin and derivatives thereof, alginates, and neutral polysaccharides such as cellulose, dextran, pullulan, starch, maltodextrin and derivatives thereof, chitin, chitosan and derivatives thereof.

In the context of the present invention, “derivative” refers to a compound resulting from another by simple addition or substitution. In the present case, a polysaccharide 1 derived from a polysaccharide 2 can have substituted hydroxyl functional groups or those modified into other functional groups. For example, hydroxyl functional groups can be transformed into ester or amide functional groups or hydroxyl functional groups can be protected, notably by protective groups, in particular as defined in Green's Protective Groups in Organic Synthesis 4^{th} ed. Particularly, a derivative includes less than 20% in number of modified functional groups.

The polysaccharide can have between 10 and 25,000 repeating units, notably between 15 and 15,000.

Preferably, the polysaccharide is a hyaluronic acid or a hyaluronic acid derivative.

According to a particular embodiment, the preparation method includes at least the following steps consisting of:
a′) reacting an acid anhydride of the following Formula A:

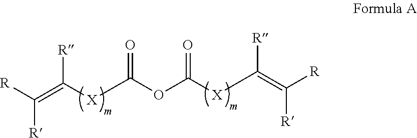

wherein:
   m is an integer between 1 and 10,
   X is a CR₁R₂ unit, wherein R₁ and R₂ are each independently a hydrogen atom, a halogen atom, a linear, branched or cyclic alkylene group having from 1 to 6 carbon atoms, an optionally substituted aryl group, or an arylalkyl group, notably benzyl,
   R, R′ and R″ are each independently a hydrogen atom, a halogen atom, a linear, branched or cyclic alkyl radical including from 1 to 6 carbon atoms, an optionally substituted aryl group, or an arylalkyl group, notably benzyl,
with hyaluronic acid,
in a solvent including, or consisting of: water and/or a polar aprotic solvent, in particular said polar aprotic solvent is selected from DMF and DMSO, and
b′) recovering the hyaluronic acid grafted with a unit having at least one carbon-carbon double bond.

The reaction conditions can be as defined above.

The hyaluronic acid can in particular have a number of repeating units between 7 and 15,000, and in particular between 15 and 7,000.

The invention also relates to the polysaccharides grafted with an alkene unit that can be obtained by the methods of the invention.

The invention relates in particular to polysaccharides having at least one alkene unit grafted on a hydroxyl or amine functional group (preferably primary amine) of said polysaccharide, said unit corresponding to the following Formula A′:

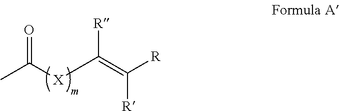

wherein
m is an integer between 1 and 10,
X is a CR₁R₂ unit, wherein R₁ and R₂ are each independently a hydrogen atom, a halogen atom, a linear, branched or cyclic alkylene group having from 1 to 6 carbon atoms, an aryl group, or an arylalkyl group, notably benzyl, and
R, R′ and R″ are each independently a hydrogen atom, a halogen atom, a linear, branched or cyclic alkyl radical having from 1 to 6 carbon atoms, an aryl group, or an arylalkyl group, in particular R, R′ and R″ are each a hydrogen atom.

The unit having at least one carbon-carbon double bond can correspond to Formula A′ wherein m is an integer between 2 and 6, in particular 4 or 5.

The unit having at least one carbon-carbon double bond can correspond to Formula A′ wherein X is CH₂.

The unit having at least one carbon-carbon double bond can correspond to Formula A′ wherein R, R′ and R″ are each a hydrogen atom.

According to a particular embodiment, the unit having at least one carbon-carbon double bond corresponds to Formula A′ wherein:
m is an integer between 2 and 6, in particular 4 or 5,
X is CH₂, and
R, R′ and R″ are each a hydrogen atom.

The unit having at least one carbon-carbon double bond can be present in particular on the polysaccharide on alcohol functional groups and/or amine functional groups, in particular primary. Thus, the unit can be linked to the polysaccharide by an ester or amide bond.

The molar graft ratio can be between 0.5 and (number of free hydroxyl functional groups per polysaccharide repeating unit)×100%, in particular between 0.5 and 400%, notably between 2 and 250%, in particular between 5 and 100%, particularly between 7 and 75%, or between 7 and 50% per polysaccharide repeating unit.

The graft ratio is deduced from the number of moles of the substituent having at least one carbon-carbon double bond per mole of polysaccharide repeating unit.

Preferably, the polysaccharide is selected from poly(galacturonate)s, heparin and derivatives thereof, hyaluronic acid and derivatives thereof, chondroitin sulfates, pectin and derivatives thereof, alginates, and neutral polysaccharides such as cellulose, dextran, pullulan, starch, maltodextrin and derivatives thereof, chitin, chitosan and derivatives thereof.

The polysaccharide can have a number of repeating units between 10 and 25,000, in particular between 15 and 15,000.

According to a preferred embodiment, the polysaccharide is dextran or a dextran derivative.

According to a preferred embodiment, the polysaccharide is hyaluronic acid or a hyaluronic acid derivative, in particular with a number of repeating units between 7 and 15,000, and in particular between 15 and 7,000.

In a preferred embodiment, the polysaccharide is the hyaluronic acid corresponding to Formula B:

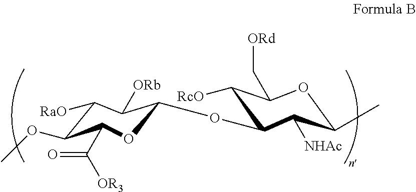

wherein
n′ is between 10 and 10,000 and in particular between 15 and 7,000,

### R₃ is H or Na,

Ra, Rb, Rc and Rd are each independently H or a unit of Formula A′ as defined above.

The invention also relates to a method for preparing a polysaccharide functionalized by at least one thioether unit grafted on a hydroxyl or amine functional group of said polysaccharide, said unit corresponding to the following Formula C:

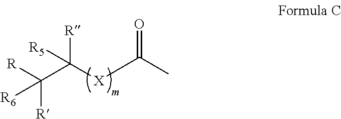

wherein
m is an integer between 1 and 10,
X is a CR₁R₂ unit, wherein R₁ and R₂ are each independently a hydrogen atom, a halogen atom, a linear, branched or cyclic alkylene group having from 1 to 6 carbon atoms, an aryl group, or an arylalkyl group,
R and R′ are each independently a hydrogen atom, a halogen atom, a linear, branched or cyclic alkyl radical having from 1 to 6 carbon atoms, an aryl group, or an arylalkyl group, in particular R and/or R′ is a hydrogen atom,
R₅ or R₆ is a hydrogen atom and the other is Rₜₕᵢₒ—S—, Rₜₕᵢₒ being a group having at least 1 carbon atom, comprising the following steps:
a) preparing a polysaccharide having at least one alkene unit grafted on at least one hydroxyl or amine functional group of said polysaccharide of the preparation method described above,
b) reacting a thiol compound, Rₜₕᵢₒ—SH, via a radical reaction with the polysaccharide obtained in the preceding step,
c) recovering the functionalized polysaccharide.

Typically, the reaction of step b) is a radical reaction. Advantageously, the radical reaction of step b) is:
photoinitiated, notably by 4-(2-hydroxyethoxy)phenyl-(2-hydroxy-2-propyl)ketone, or
initiated by a water soluble initiator, without UV light, such as azobis-(2-methylpropionamidine)dihydrochloride, or 2,2′-azobis[2(2-imidazolin-2-yl)propane]dihydrochloride.

In the methods of the invention, step b) is carried out preferably in a solvent selected from water or a water/ethanol, water/isopropanol, water/DMF or water/DMSO mixture.

5

Step b) can be carried out after purification, notably by precipitation or ultrafiltration. Step b) can include irradiation with UV light, notably at a wavelength of 365 nm. The radical reaction of step b) can be photoinitiated, notably by 4-(2-hydroxyethoxy)phenyl-(2-hydroxy-2-propyl)ketone, sold under the name Irgacure 2959, or can be initiated by a water soluble initiator, without UV light, such as, for example, azobis-(2-methylpropionamidine)dihydrochloride, sold under the name V-50 (Wako) or 2,2′-azobis[2(2-imidazolin-2-yl)propane]dihydrochloride, sold under the name V-044 (Wako).

This reaction can be carried out in a solvent selected from water or a water/ethanol, water/isopropanol, water/DMF or water/DMSO mixture notably at a volume ratio from 4/1 to 1/1.

The reaction of step b) can be carried out for a period of 1 to 120 minutes, in particular from 1 to 60 minutes, in particular from 1 to 20 minutes when a photoinitiator is used.

When the reaction is initiated with a water-soluble azo initiator, the reaction can be carried out for a period of 4 to 24 hours.

The unit having at least one carbon-carbon double bond can be functionalized with one or more thiol compounds. When several thiol compounds are used, they can be added sequentially or can be added and reacted simultaneously.

In particular, two or three thiol compounds “of interest” can be used. In particular, these thiols of interest can interact among themselves, notably after grafting, in particular in order to obtain a “complex” functionalization with several components.

Particularly, depending on its reactivity, the thiol compound can be used in an equimolar quantity or in excess, for example from 1 to 3 molar equivalents in relation to the carbon-carbon double bond.

The thiol compound, Rₜₕᵢₒ—SH, can be any type of thiol. Rₜₕᵢₒ is a group having at least one carbon atom and more particularly at least one carbon atom bound to the —SH functional group. It can, for example, be selected from:
alkyl thiols, notably linear, branched or cyclic alkyls, for example pentanethiol or decanethiol,
aryl thiols, notably heteroaryls, having for example a nitrogen and/or sulfur atom,
synthetic polymers, belonging notably to the family of polyethers, such as poly(ethylene glycol)s, bearing at least one thiol functional group, Pluronics bearing at least one thiol functional group, to the family of poly(N-alkylacrylamide)s, such as (poly(N-isopropylacrylamide)), bearing at least one thiol functional group,
mono-, oligo- or polysaccharides bearing at least one thiol functional group, for example at the reducing end or along the oligo- or polysaccharide chain,
peptides bearing at least one thiol functional group,
oligonucleotides bearing at least one thiol functional group,
compounds having at least two thiol functional groups, notably two, three, four, five or six thiol functional groups, and
active compounds, notably pharmaceutically active compounds, bearing at least one thiol functional group.

For example, the thiol compound can be a steroid, notably alpha-thiocholesterol, an oligo- or polypeptide, notably including serine.

The thiol Rₜₕᵢₒ—SH can also be a derivative of the compounds cited above, but also, for example, can be a derivative of:
a steroid, such as cholesterol,
a peptide, for example including the amino acid sequence arginine-glycine-aspartic acid, Arg-Gly-Asp, more commonly called RGD,
cyclodextrin, such as 6′-amino-6′-deoxycyclomaltoheptaose.

The thiol derivatives Rₜₕᵢₒ—SH, in particular of molecules of interest, can be obtained by grafting a thiol functional group, for example:
by grafting cysteamine, in particular with compounds bearing a carboxylic acid functional group, or
by grafting mercaptopropionic acid, notably with compounds bearing an alcohol or amine functional group.

The presence of these reactive units on the polysaccharide enables the effective and controlled grafting in an aqueous medium of molecules or varied active macromolecules and/or its chemical crosslinking via a “thiol-click” reaction.

This reaction is orthogonal to a large variety of functional groups, which makes it possible, for example, to physically incorporate biomolecules or complex biomacromolecules (drugs, peptides), or even cells in the reaction mixture during the synthesis of polysaccharide-based biomaterials.

According to another aspect, the invention relates to a method for preparing grafted polysaccharide functionalized by a thioether unit, comprising at least the following steps consisting of:
reacting a thiol compound, Rₜₕᵢₒ—SH, with a polysaccharide grafted with a unit having at least one carbon-carbon double bond via a radical reaction, in particular with a grafted hyaluronic acid as described above,
recovering the polysaccharide functionalized by a thioether, notably of Formula C.

Particularly, this method is carried out following the method for preparing polysaccharide grafted with a unit having at least one carbon-carbon double bond as described above.

Preferably, the polysaccharide used in the methods described above is selected from poly(galacturonate)s, heparin and derivatives thereof, hyaluronic acid and derivatives thereof, chondroitin sulfates, pectin and derivatives thereof, alginates, and neutral polysaccharides such as cellulose, dextran, pullulan, starch, maltodextrin and derivatives thereof, chitin, chitosan and derivatives thereof. The polysaccharide can have a number of repeating units between 10 and 25,000, in particular between 15 and 15,000.

In a preferred embodiment, the polysaccharide is selected from hyaluronic acid and derivatives thereof and dextran and derivatives thereof.

Particularly, the invention relates to a method for preparing grafted hyaluronic acid functionalized by a unit having at least one carbon-carbon double bond, comprising at least the following steps consisting of:
c) reacting a thiol compound, notably Rₜₕᵢₒ—SH, in particular having at least 3 carbon atoms, with a hyaluronic acid grafted with a unit including a unit having at least one carbon-carbon double bond, in particular with a grafted hyaluronic acid as described above,
d) recovering the hyaluronic acid functionalized by a thioether, in particular by a thioether of Formula C, and in particular the hyaluronic acid is the hyaluronic acid of Formula D below.

The invention also relates to a polysaccharide functionalized by at least one thioether unit grafted on a hydroxyl or amine functional group of said polysaccharide, said unit corresponding to the following Formula C:

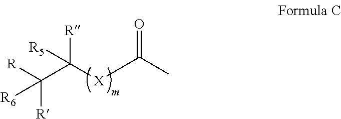

wherein
m is an integer between 1 and 10,
X is a CR₁R₂ unit, wherein R₁ and R₂ are each independently a hydrogen atom, a halogen atom, a linear, branched or cyclic alkylene group having from 1 to 6 carbon atoms, an aryl group, or an arylalkyl group,
R and R′ are each independently a hydrogen atom, a halogen atom, a linear, branched or cyclic alkyl radical having from 1 to 6 carbon atoms, an aryl group, or an arylalkyl group, in particular R and/or R′ is a hydrogen atom,
R₅ or R₆ is a hydrogen atom and the other is Rₜₕᵢₒ—S—, Rₜₕᵢₒ being a group having at least 1 carbon atom.

According to another of its aspects, the invention relates to a polysaccharide grafted alkene functionalized by a thioether group, said alkene functionalized by a thioether group corresponding to following Formula C:

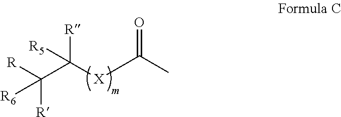

wherein
   m is an integer between 1 and 10,
   X is a CR₁R₂ unit, wherein R₁ and R₂ are each independently a hydrogen atom, a halogen atom, a linear, branched or cyclic alkylene group having from 1 to 6 carbon atoms, an optionally substituted aryl group, or an arylalkyl group, notably benzyl,
   R and R′ are each independently a hydrogen atom, a halogen atom, a linear, branched or cyclic alkyl radical having from 1 to 6 carbon atoms, an optionally substituted aryl group, or an arylalkyl group, notably benzyl, in particular R and/or R′ is a hydrogen atom, and
   R₅ or R₆ is a hydrogen atom and the other is Rₜₕᵢₒ—S—, Rₜₕᵢₒ being a group having at least 1 carbon atom.

The Rₜₕᵢₒ—S— group can be present on the less substituted carbon of Formula C, and in particular R₆ is Rₜₕᵢₒ—S— and R₅ is H.

In particular, said alkene functionalized by a thioether group corresponds to following Formula C:

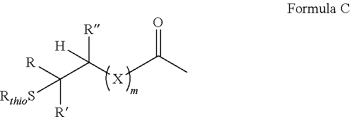

wherein R, R′, R″, Rₜₕᵢₒ—S—, X and m are as defined above for Formula C.

Particularly, R and/or R′ are/is H.

The Rₜₕᵢₒ—S— can be a group derived from a thiol compound as defined in the present description or can be a polymer.

The grafted and functionalized polysaccharide can have a graft ratio in units including a functionalized carbon-carbon double bond of Formula C between 0.5 and (number of free hydroxyl functional groups per polysaccharide repeating unit)×100%, in particular between 0.5 and 400%, notably between 2 and 250%, in particular between 5 and 100%, particularly between 7 and 75%, even between 7 and 50% per polysaccharide repeating unit.

Particularly, all the units including a carbon-carbon double bond are functionalized. The functionalization can be achieved by one or more different thiols.

The Rₜₕᵢₒ—S— group coming from the thiol compound can come from any type of thiol. This Rₜₕᵢₒ—S— group coming from the thiol compound can come from the compounds as described above or from compounds selected from:
alkyl thiols, notably linear, branched or cyclic alkyls, for example pentanethiol or decanethiol,
aryl thiols, notably heteroaryls, having for example a nitrogen and/or sulfur atom,
synthetic polymers, belonging notably to the family of polyethers, such as poly(ethylene glycol)s, bearing at least one thiol functional group, Pluronics bearing at least one thiol functional group, to the family of poly(N-alkylacrylamide)s (poly(N-isopropylacrylamide)) bearing at least one thiol functional group,
mono-, oligo- or polysaccharides bearing at least one thiol functional group, for example at the reducing end or along the oligo- or polysaccharide chain,
peptides bearing at least one thiol functional group,
oligonucleotides bearing at least one thiol functional group,
compounds having at least two thiol functional groups, notably two, three, four, five or six thiol functional groups, and
active compounds, notably pharmaceutically active compounds, bearing at least one thiol functional group.

For example the Rₜₕᵢₒ—S— group derived from the thiol compound can come from a steroid, notably alpha-thiocholesterol, an oligo- or polypeptide.

The thiol can also be a derivative of the compounds cited above, but also, for example, can be a derivative of a:
steroid, such as cholesterol,
peptide, for example including the amino acid sequence arginine-glycine-aspartic acid, Arg-Gly-Asp, more commonly called RGD,
cyclodextrin, such as 6′-amino-6′-deoxycyclomaltoheptaose.

The thiol derivatives, in particular of molecules of interest, can be obtained by grafting a thiol functional group, for example:
by grafting of cysteamine, in particular with compounds bearing a carboxylic acid functional group, or
by grafting of mercaptopropionic acid, in particular with compounds bearing an alcohol or amine functional group.

More generally, the Rₜₕᵢₒ—S— group derived from the thiol compound can come from any type of thiol, in particular as described in the present description.

The polysaccharide is as defined in the present invention. Preferably, the polysaccharide is dextran or a dextran derivative. Preferably, the polysaccharide is hyaluronic acid or a hyaluronic acid derivative.

In a preferred embodiment, the polysaccharide is the hyaluronic acid corresponding to Formula D:

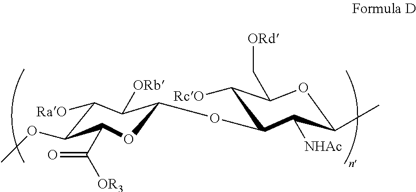

wherein
n′ is between 10 and 10,000, and in particular between 15 and 7,000,

### R₃ is H or Na, and

Ra′, Rb′, Rc′ and Rd′ are each independently H or a unit of Formula C as defined above.

In particular, said unit of Formula C is present at a molar graft ratio between 0.5 and 400%, notably between 2 and 250%, in particular between 5 and 100%, particularly between 7 and 75%, even between 7 and 50% per hyaluronic acid repeating unit.

The functionalization can be achieved by one or more different thiols.

When the method of the invention is carried out with a thiol compound including several thiol functional groups, the method leads to a crosslinking of the polysaccharide.

According to another particular embodiment, the thiol compound Rₜₕᵢₒ—SH includes several thiol functional groups, in particular 1, 2, 3 or 4. They can, for example, be the poly(ethylene glycol) derivatives sold by Shearwater (http://www.creativepegworks.com). The thiol compound can be:
a CZ₄₋ᵣ(O(CH₂CH₂O)_{q}CH₂CH₂SH)ᵣ compound wherein Z is H or an alkyl group, notably including from 1 to 18 carbon atoms, q is an integer between 2 and 150, notably between 4 and 100, and in particular between 5 and 75, and r is an integer between 1 and 4, or
a HSCH₂CH₂—O—(CH₂CH₂O)_{S}CH₂CH₂SH compound wherein S is an integer between 10 and 500, notably between 20 and 250, particularly between 25 and 150.

Thus, the invention also relates to a method for crosslinking hyaluronic acid comprising the following steps:
a) preparing a hyaluronic acid having at least one alkene unit grafted on at least one hydroxyl functional group of said hyaluronic acid of the preparation method described above,
b) reacting a compound including several thiol functional groups with the hyaluronic acid obtained in the preceding step,
c) recovering the crosslinked hyaluronic acid.

Preferably, the compound including several thiol functional groups is selected from poly(ethylene glycol)dithiol and poly(ethylene)tetrathiol.

Advantageously, step b) is carried out via a radical reaction. Preferably, step b) includes irradiation with UV light.

In preferred embodiments, the HA crosslinking methods further include the hydration of hyaluronic acid to form a hydrogel.

The invention also relates to the crosslinked hyaluronic acid that can be obtained by a method of the invention and to the hyaluronic acid hydrogel that can be obtained by a method of the invention.

The present invention also relates to a method for preparing crosslinked hyaluronic acid functionalized by at least one thioether unit, comprising the preparation of a hyaluronic acid functionalized by a preparation method of the invention and the crosslinking of the hyaluronic acid of the invention.

The invention also relates to a functionalized crosslinked hyaluronic acid that can be obtained by a method of the invention as well as to a controlled-release pharmaceutical or cosmetic composition comprising one such functionalized crosslinked hyaluronic acid, a functionalized polysaccharide of the invention or a hyaluronic acid hydrogel of the invention.

The invention also relates to a composition comprising a polysaccharide grafted with a unit having at least one carbon-carbon double bond or a polysaccharide functionalized by a thioether unit. This composition can also include a preservative. The present solution can thus include an antioxidant agent and/or an antibacterial agent, for example mannitol or azide of sodium.

This composition can also include a preservative. The present solution can thus include an antioxidant agent and/or an antibacterial agent, for example mannitol or azide of sodium.

The invention also relates to polysaccharides that can be obtained by the methods of the invention.

According to another aspect, the invention relates to a composition comprising, or consisting of, at least one polysaccharide grafted with a unit having at least one carbon-carbon double bond and/or at least one grafted polysaccharide functionalized by a thioether unit.

According to another aspect, the invention relates to a material comprising at least one polysaccharide grafted with a unit having at least one carbon-carbon double bond, at least one grafted polysaccharide functionalized by a thioether unit, at least one composition comprising at least one polysaccharide grafted with a unit having at least one carbon-carbon double bond and/or at least one grafted polysaccharide functionalized by a thioether unit.

Chemical gels in solutions can also be obtained by mixing functional polymers, notably bearing one or more thiol functional groups, with a polysaccharide bearing a unit including a carbon-carbon double bond. This type of gel is optionally injectable, in particular for biomedical applications.

The polysaccharides grafted by a unit including a carbon-carbon double bond can also be functionalized with active compounds, notably pharmaceutically active compounds, or derivatives of these compounds, bearing a thiol functional group, or with bioactive polymers. These materials can thus enable a fine addressing of the drug.

### FIGURES

FIG. 1 represents the variation of the conservation module, G′, as a function of time at 25° C. for various HA-pentenoate/PEG-(SH)₄ and HA-pentenoate/PEG-(SH)₂ mixtures of the invention.

### EXAMPLES

In the following examples, the syntheses and analyses were carried out using water purified by an Elga Purelab system with a resistivity of 18.2 MΩ·cm.

The modified polysaccharides were analyzed by ¹H NMR in order to confirm the grafting and the purity of the final polymers. The molar mass and average molar mass distributions of the modified polysaccharides were measured by triple-detection steric exclusion chromatography (equipped with a differential refractometer, a capillary viscometer and a multi-angle light scattering apparatus).

The low resolution MALDI-TOF mass spectrometry measurements were made with a Bruker Daltonics Autoflex spectrometer. The matrix used is 2,5-dihydrobenzoic acid (DHB) at a concentration of 50 mg/ml in H₂O.

Photorheometry measurements were made using an AR2000Ex rheometer (TA Instruments) equipped with a UV irradiation cell.

### Example 1

### Synthesis of a HA-Pentenoate Derivative Having a Graft Ratio of 20%

Procedure for Grafting Pentenoate Groups on Hyaluronic Acid from an Initial Batch of HA of Mass M_{W}=200,000 g/mol.

Hyaluronic acid with a weight average molar mass (M_{W}, g/mol) of 200,000 (0.200 g, 0.50 mmol) is solubilized in ultrapure water (10 ml) under stirring (2% w/v HA solution).

To this solution is added dimethylformamide (DMF, 6.7 ml) under stirring (water/DMF mixture, 3/2 (v/v)). The pH of the reaction mixture is adjusted to 8.3 (8<pH<9) by adding 0.5 M aqueous sodium hydroxide solution and then it is cooled to 4° C.

4-Pentenoic anhydride (0.091 g, 0.50 mmol) solubilized beforehand in 1 ml of DMF is then added dropwise to the reaction mixture under stirring.

The pH is maintained at 8.3 for 4 hours and then the mixture is refrigerated at 4° C. overnight.

After having left the reaction medium at 4° C. under stirring overnight, the solution is transferred for the diafiltration step (Amicon YM10 membrane, 10,000 Da cutoff). It is washed with a water/ethanol mixture (3/2, v/v) at 20° C. until the permeate has a conductivity equivalent to that of ultrapure water.

The permeate is then transferred to the rotary evaporator in order to remove the ethanol present.

The final polymer is isolated after lyophilization with a yield of 96%. Its graft ratio determined by ¹H NMR is 20%.

¹H NMR (D₂O, 400 MHz, 80° C., δ (ppm)): 1.94 (HA acetyl group CH₃), 2.32 (m, CH₂—CH═CH₂), 2.48 (m, CH₂—CO), 3.10-4.00 (m, mass of the protons of the sugars of the HA backbone), 4.38-4.55 (m, anomeric protons of HA), 5.01 (m, CH₂═), 5.83 (m, CH═).

Weight average molar mass measured by SEC: M_{W}=370,000 g/mol.

### Example 2

### Synthesis of a Dextran-Pentenoate Derivative Having a Graft Ratio of 20%

Procedure for Grafting Pentenoate Groups on Dextran from an Initial Batch of Dextran of Mass M_{W}=200,000 g/mol.

Dextran with a weight average molar mass (M_{W}, g/mol) of 200,000 (0.200 g, 1.23 mmol) is solubilized in ultrapure water (10 ml) under stirring (2% w/v dextran solution).

To this solution is added DMF (6.7 ml) under stirring (water/DMF mixture, 3/2 (v/v)). The reaction mixture is cooled to 4° C. and then its pH is adjusted to 8.3 (8<pH<9) by adding 0.5 M aqueous sodium hydroxide solution.

4-Pentenoic anhydride (0.091 g, 0.50 mmol) solubilized beforehand in 1 ml of DMF is added dropwise to the reaction mixture.

The pH is maintained at 8.3 for 4 hours and then the mixture is refrigerated at 4° C. overnight.

After having left the reaction medium at 4° C. under stirring overnight, the solution is transferred for the diafiltration step (Amicon YM10 membrane, 10,000 Da cutoff). It is washed with a water/ethanol mixture (3/2, v/v) at 20° C. until the permeate has conductivity equivalent to that of ultrapure water.

The permeate is then transferred to a rotary evaporator in order to remove the ethanol present.

The final polymer is isolated after lyophilization (24 hours) with a yield of 84%.

Its graft ratio determined by ¹H NMR is 20%.

¹H NMR (D₂O, 400 MHz, 80° C., δ (ppm)): 2.34 (m, CH₂—CH═CH₂) 2.53 (m, CH₂—CO), 3.30-4.10 (m, mass of the protons of the sugars of the dextran backbone), 4.91 (m, anomeric protons of HA), 5.07 (m, CH₂═), 5.82 (m, CH═).

### Example 3

### Synthesis of a HA-Cyclodextrin Derivative Having a β-Cyclodextrin (CD) Graft Ratio of 18%

### a. Synthesis of 6′-mercaptopropionylamido-6′-deoxycyclomaltoheptaose

To a solution of 6′-amino-6′-deoxycyclomaltoheptaose (SIGMA) (0.2 g, 0.17 mmol) in DMF (20 ml), under stirring and nitrogen atmosphere, are added successively N,N-diisopropylethylamine (DIEA, 0.029 ml, 0.17 mmol) in solution in DMF (1 ml), 1-hydroxybenzotriazole (HOBt, 0.046 g, 0.34 mmol) and N,N′-diisopropylcarbodiimide (DIC) (0.106 ml, 0.68 mmol) also in solution in DMF (1 ml). Mercaptopropionic acid (MPA, 0.019 ml, 0.22 mmol) is then added to the reaction medium. The reaction mixture is then left under stirring overnight under nitrogen atmosphere. After evaporation of most of the DMF in a rotary evaporator, the product is precipitated in acetone (200 ml). The precipitate is then is washed 3 times on a frit with a porosity of 5 with 100 ml of acetone and then dried at room temperature overnight. 6′-Mercaptopropionylamido-6′-deoxycyclomaltoheptaose is obtained in the form of a white powder (0.181 g, 0.15 mmol) with a yield of 88%.

¹H NMR (D₂O, 400 MHz, 25° C., δ (ppm)): 2.53 (m, CH₂—SH, MPA chain), 2.67 (m, CH₂—CO, MPA link), 3.13 (m, 1H, CD), 3.35 (m, 1H, CD), 3.52-3.86 (m, H-2, H-3, H-4, H-5, H-6, 6′, CD), 5.0 (m, anomeric protons, CD)

MS-MALDI-TOF: [M+Na]⁺ calculated for C₄₅H₇₄O₃₅NSNa: 1244.11; Measured: 1244.40

### b. Coupling of 6′-mercaptopropionylamido-6′-deoxycyclomaltoheptaose with a HA-Pentenoate Derivative Having a Graft Ratio of 20%

To a solution of HA-pentenoate of mass M_{W}=370,000 g/mol having a graft ratio of 20% (synthesized according to Example 1) in ultrapure water (2 ml) (1% w/v HA-pentenoate solution) under stirring is added 6′-mercaptopropionylamido-6′-deoxycyclomaltoheptaose (0.012 g, 0.0096 mmol). To the mixture is then added a 1% (w/v) Irgacure 2959 solution in PBS (0.1 ml, phosphate buffered saline, 0.15 M NaCl, pH 7.4). The reaction mixture is then transferred to a quartz cell and irradiated for 5 minutes at a wavelength λ=365 nm.

The solution is then transferred for the diafiltration step (Amicon YM10 membrane, 10,000 Da cutoff) and is washed with 20° C. ultrapure water until the permeate has a conductivity equivalent to that of ultrapure water.

The final polymer is isolated after lyophilization with a yield of 87%.

Its graft ratio determined by ¹H NMR is 18%.

¹H NMR (D₂O, 400 MHz, 80° C., δ (ppm)): 1.59 (m, CH₂, CO—CH₂—CH₂—CH₂—CH₂—S), 1.91 (HA acetyl CH₃ group), 2.41 (m, CO—CH₂—CH₂—CH₂—CH₂—S, S—CH₂—CH₂—CO—NH), 2.41 (m, S—CH₂—CH₂—CO—NH), 3.20-4.00 (m, mass of the protons of the sugars of the HA backbone and of the CD), 4.35-4.50 (m, anomeric protons of HA), 4.97 (m, anomeric protons of CD).

### Example 4

### Synthesis of a HA-RGD Derivative Having a Graft Ratio in RGD Peptide Units of 20%

To a solution of HA-pentenoate of mass M_{W}=370,000 g/mol and having a graft ratio of 20% (synthesized according to Example 1) in ultrapure water (1.8 ml) (1% w/v HA-pentenoate solution) under stirring is added the RGD peptide (MPA-gly-arg-gly-asp-ser from Genecust, 0.005 g, 0.0086 mmol). To the mixture is then added a 1% (w/v) Irgacure 2959 solution in PBS (0.1 ml, phosphate buffered saline, 0.15 M NaCl, pH 7.4). The reaction mixture is then transferred to a quartz cell and irradiated for 5 minutes at a wavelength λ=365 nm.

The solution is then transferred for the diafiltration step (Amicon YM10 membrane, 10,000 Da cutoff) and is washed with 20° C. ultrapure water until the permeate has a conductivity equivalent to that of ultrapure water.

The final polymer is isolated after lyophilization with a yield of 76%.

Its graft ratio determined by ¹H NMR is 20%.

¹H NMR (D₂O, 400 MHz, 80° C., δ (ppm)): 1.54-1.67 (m, 3 CH₂ arginine), 2.53 (m, CH₂CO, mercaptopropionamide), 2.73 (m, CH₂ aspartic acid), 3.11 (t, CH₂S), 3.20-4.00 (m, mass of the protons of the sugars of the HA backbone, CH₂ glycine, CH₂ serine), 4.24-4.66 (m, anomeric protons of HA, CH arginine, CH aspartic acid, CH serine).

### Example 5

### Synthesis of a HA-Pentane Derivative Having a Pentane Chain Graft Ratio of 20%

To a solution of HA-pentenoate having a graft ratio of 20% (synthesized according to Example 1) in an ultrapure water/ethanol mixture (3/2, v/v, 5 ml) (1% w/v HA-pentenoate solution) under stirring is added 1-pentanethiol (0.012 g, 0.119 mmol). To the mixture is then added a 1% (w/v) Irgacure 2959 solution in a water/ethanol mixture (3/2, v/v, 0.1 ml). The reaction mixture is then transferred to a quartz cell and irradiated for 10 minutes at a wavelength λ=365 nm.

The solution is then transferred for the diafiltration step (Amicon YM10 membrane, 10,000 Da cutoff) and is washed with an ultrapure water/ethanol mixture (3/2, v/v) at 20° C. until the permeate has a conductivity equivalent to that of ultrapure water.

The final polymer is isolated after lyophilization with a yield of 75%.

Its graft ratio determined by ¹H NMR is 20%.

¹H NMR (D₂O, 400 MHz, 80° C., δ (ppm)): 0.77 (t, S—(CH₂)₄—CH₃), 1.23 (m, S—CH₂—CH₂—CH₂—CH₂—CH₃), 1.50 (m, CO—CH₂—CH₂—CH₂—CH₂—S, S—CH₂—CH₂—CH₂—CH₂—CH₃), 1.91 (HA acetyl group CH₃), 2.48 (m, CO—CH₂—CH₂—CH₂—CH₂—S, S—CH₂—CH₂—CH₂—CH₂—CH₃), 3.10-4.00 (m, mass of the protons of the sugars of the HA backbone), 4.34-4.55 (m, anomeric protons of HA).

### Example 6

### Synthesis of, a Dextran-Cyclodextrin Derivative Having a β-Cyclodextrin (CD) Graft Ratio of 10%

To a solution of dextran-pentenoate of mass M_{W}˜200,000 g/mol and having a graft ratio of 20% (synthesized according to Example 2) in ultrapure water (2 ml) (1% w/v dextran-pentenoate solution) under stirring is added 6′-mercaptopropionylamido-6′-deoxycyclomaltoheptaose (0.027 g, 0.00224 mmol). To the mixture is then added a 1% (w/v) Irgacure 2959 solution in PBS (0.1 ml, phosphate buffered saline, 0.15 M NaCl, pH 7.4). The reaction mixture is then transferred to a quartz cell and irradiated for 5 minutes at a wavelength λ=365 nm.

The solution is then transferred for the diafiltration step (Amicon YM10 membrane, 10,000 Da cutoff) and is washed with 20° C. ultrapure water until the permeate has a conductivity equivalent to that of ultrapure water.

The final polymer is isolated after lyophilization with a yield of 100%.

Its graft ratio determined by ¹H NMR is 10%.

¹H NMR (D₂O, 400 MHz, 80° C., δ (ppm)): 1.64 (m, CO—CH₂—CH₂—CH₂—CH₂—S), 2.40-2.50 (m, CO—CH₂—CH₂—CH₂—CH₂—S, S—CH₂—CH₂—CO—NH), 2.72 (m, S—CH₂—CH₂—CO—NH), 3.20-4.00 (m, mass of the protons of the sugars of the dextran backbone and CD), 4.88 (m, anomeric protons of dextran), 4.99 (m, anomeric protons of β-CD).

### Example 7

### Syntheses of Chemical Hydrogels Containing Hyaluronic Acid

When the HA-pentenoate derivatives are brought together with compounds having several thiol functional groups (poly(ethylene glycol)dithiol (PEG-(SH)₂, M_{W}=3,600 g/mol, Shearwater) of the following Formula,

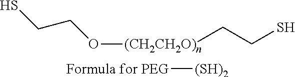

or poly(ethylene glycol)tetrathiol (PEG-(SH)₄, M_{W}=2,200 g/mol, Shearwater) of the following Formula

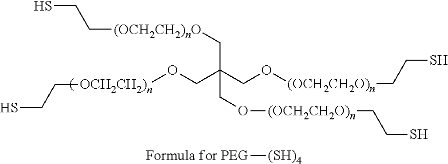

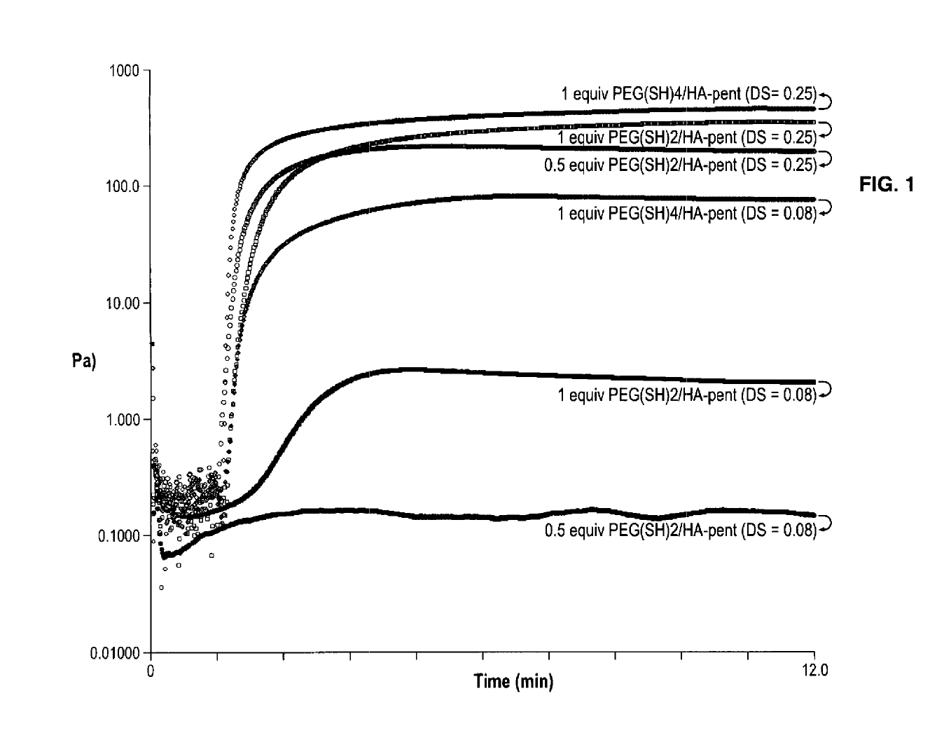

the formation of chemical hydrogels by UV irradiation is observed. This was followed by photorheology (AR2000 Ex rheometer, TA Instruments) as presented in FIG. 1.

FIG. 1 represents the variation of the conservation module, G′, as a function of time at 25° C. for various HA-pentenoate/PEG-(SH)₄ and HA-pentenoate/PEG-(SH)₂ mixtures prepared from HA-pentenoate derivatives having a graft ratio of 8% (noted HA-pent (DS=0.08)) or of 25% (noted HA-pent (DS=0.25)). The PEG-(SH)₄ (M_{W}=2,200 g/mol) and PEG-(SH)₂ (M_{W}=3,600 g/mol) derivatives are from Shearwater. UV radiation is activated 1 minute after beginning the measurement of the module G′ carried out at a set frequency of 1 Hz. The initial concentration of HA-pentenoate (M_{W}=200,000 g/mol) in PBS is 15 g/l.

According to this FIG. 1, the conservation module (elastic), G′, expressing the establishment of interchain chemical bridges, grows abruptly from the activation of UV radiation (λ=365 nm, power: 144 mW/cm²) to reach a constant value after 5 minutes. The values of the modules can be modulated as a function of the thiol/pentenoate molar ratio, the degree of substitution of the HA-pentenoate, the nature of the thiol derivative and the HA-pentenoate concentration.

1-27. (canceled)

28. A method for preparing a polysaccharide having at least one alkene unit grafted on a hydroxyl or amine functional group of said polysaccharide, said alkene unit corresponding to the following Formula A′: 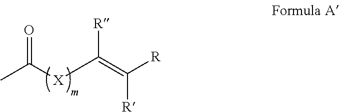
wherein
m is an integer between 1 and 10,
X is a CR1R2 unit, wherein R1 and R2 are each independently a hydrogen atom, a halogen atom, a linear, branched or cyclic alkylene group having from 1 to 6 carbon atoms, an aryl group, or an arylalkyl group, and
R, R′ and R″ are each independently a hydrogen atom, a halogen atom, a linear, branched or cyclic alkyl radical having from 1 to 6 carbon atoms, an aryl group, or an arylalkyl group,
comprising the following steps:
a) reacting an acid anhydride of the following Formula A: 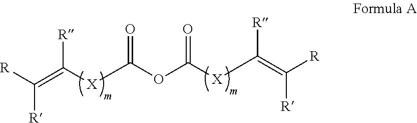
wherein:
m is an integer between 1 and 10,
X is a CR1R2 unit, wherein R1 and R2 are each independently a hydrogen atom, a halogen atom, a linear, branched or cyclic alkylene group having from 1 to 6 carbon atoms, an aryl group, or an arylalkyl group, and
R, R′ and R″ are each independently a hydrogen atom, a halogen atom, a linear, branched or cyclic alkyl radical having from 1 to 6 carbon atoms, an aryl group, or an arylalkyl group,
with at least one polysaccharide,
in a hydro-organic solvent comprised of water and a polar aprotic solvent or a polar protic solvent,
b) recovering the polysaccharide including a grafted alkene unit.

29. The method according to claim 28, wherein step a) is carried out in a water/DMF, water/DMSO or water/isopropanol mixture.

30. The method according to claim 28, wherein step a) is carried out at a pH between 6 and 11.

31. The method according to claim 28, wherein in step a) the molar graft ratio is modulated by the quantity of anhydride added.

32. The method according to claim 28, wherein the polysaccharide is selected from poly(galacturonate)s, heparin and derivatives thereof, hyaluronic acid and derivatives thereof, chondroitin sulfates, pectin and derivatives thereof, alginates, and neutral polysaccharides such as cellulose, dextran, pullulan, starch, maltodextrin and derivatives thereof, chitin, chitosan and derivatives thereof.

33. A polysaccharide having at least one alkene unit grafted on a hydroxyl or amine functional group of said polysaccharide, said unit corresponding to the following Formula A′: 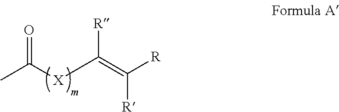
wherein
m is an integer between 1 and 10,
X is a CR1R2 unit, wherein R1 and R2 are each independently a hydrogen atom, a halogen atom, a linear, branched or cyclic alkylene group having from 1 to 6 carbon atoms, an aryl group, or an arylalkyl group, and
R, R′ and R″ are each independently a hydrogen atom, a halogen atom, a linear, branched or cyclic alkyl radical having from 1 to 6 carbon atoms, an aryl group, or an arylalkyl group.

34. The polysaccharide according to claim 33, wherein the molar graft ratio is from 0.5 to (number of free hydroxyl functional groups per polysaccharide repeating unit)×100% per polysaccharide repeating unit.

35. The polysaccharide according to claim 33, wherein said polysaccharide is selected from poly(galacturonate)s, heparin and derivatives thereof, hyaluronic acid and derivatives thereof, chondroitin sulfates, pectin and derivatives thereof, alginates, and neutral polysaccharides such as cellulose, dextran, pullulan, starch, maltodextrin and derivatives thereof, chitin, chitosan and derivatives thereof.

36. The polysaccharide according to claim 33, wherein said polysaccharide is the hyaluronic acid of Formula B: 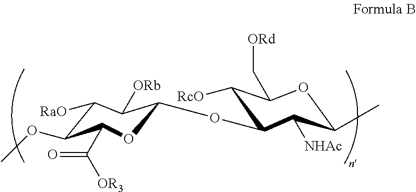
wherein
n′ is between 10 and 10,000,
R3 is H or Na,
Ra, Rb, Rc and Rd are each independently H or a unit of Formula A′ as defined in claim 33.

37. A method for preparing a polysaccharide functionalized by at least one thioether unit grafted on a hydroxyl or amine functional group of said polysaccharide, said unit corresponding to the following Formula C: 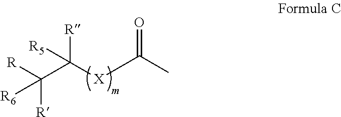
wherein
m is an integer between 1 and 10,
X is a CR1R2 unit, wherein R1 and R2 are each independently a hydrogen atom, a halogen atom, a linear, branched or cyclic alkylene group having from 1 to 6 carbon atoms, an aryl group, or an arylalkyl group,
R and R′ are each independently a hydrogen atom, a halogen atom, a linear, branched or cyclic alkyl radical having from 1 to 6 carbon atoms, an aryl group, or an arylalkyl group,
R5 or R6 is a hydrogen atom and the other is Rthio-S, Rthio being a group having at least 1 carbon atom,
comprising the following steps:
a) preparing a polysaccharide having at least one alkene unit grafted on a hydroxyl or amine functional group of said polysaccharide of the preparation method of claim 28,
b) reacting a thiol compound, Rthio-SH, via a radical reaction with the polysaccharide obtained in the preceding step,
c) recovering the functionalized polysaccharide.

38. The method according to claim 37, wherein the radical reaction of step b) is:
photoinitiated, or
initiated by a water soluble initiator, without UV light.

39. The method according to claim 37, wherein step b) is carried out in a solvent selected from water or a water/ethanol, water/isopropanol, water/DMF or water/DMSO mixture.

40. The method according to claim 37, wherein the polysaccharide is selected from poly(galacturonate)s, heparin and derivatives thereof, hyaluronic acid and derivatives thereof, chondroitin sulfates, pectin and derivatives thereof, alginates, and neutral polysaccharides such as cellulose, dextran, pullulan, starch, maltodextrin and derivatives thereof, chitin, chitosan and derivatives thereof.

41. A polysaccharide functionalized by at least one thioether unit grafted on a hydroxyl or amine functional group of said polysaccharide, said unit corresponding to the following Formula C: 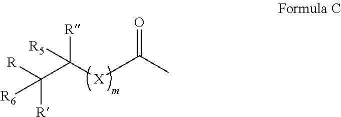
wherein
m is an integer between 1 and 10,
X is a CR1R2 unit, wherein R1 and R2 are each independently a hydrogen atom, a halogen atom, a linear, branched or cyclic alkylene group having from 1 to 6 carbon atoms, an aryl group, or an arylalkyl group,
R and R′ are each independently a hydrogen atom, a halogen atom, a linear, branched or cyclic alkyl radical having from 1 to 6 carbon atoms, an aryl group, or an arylalkyl group,
R5 or R6 is a hydrogen atom and the other is Rthio-S, Rthio being a group having at least 1 carbon atom.

42. The polysaccharide according to claim 41, wherein the graft ratio in thioether units of Formula C is between 0.5 and (number of free hydroxyl functional groups per polysaccharide repeating unit)×100% per polysaccharide repeating unit.

43. The polysaccharide according to claim 41, wherein the Rthio-S comes from compounds selected from:
alkyl thiols, notably linear, branched or cyclic alkyls,
aryl thiols,
synthetic polymers, bearing at least one thiol functional group, Pluronics bearing at least one thiol functional group, to the family of poly(N-alkylacrylamide)s bearing at least one thiol functional group,
mono-, oligo- or polysaccharides bearing at least one thiol functional group, peptides bearing at least one thiol functional group,
oligonucleotides bearing at least one thiol functional group, and
active compounds, bearing at least one thiol functional group,
steroids,
cyclodextrins
compounds having at least two thiol functional groups, and
poly(ethylene glycol)s.

44. The polysaccharide according to claim 41 wherein said polysaccharide is selected from poly(galacturonate)s, heparin and derivatives thereof, hyaluronic acid and derivatives thereof, chondroitin sulfates, pectin and derivatives thereof, alginates, and neutral polysaccharides such as cellulose, dextran, pullulan, starch, maltodextrin and derivatives thereof, chitin, chitosan and derivatives thereof.

45. The polysaccharide according to claim 41, wherein said polysaccharide is the hyaluronic acid corresponding to Formula D: 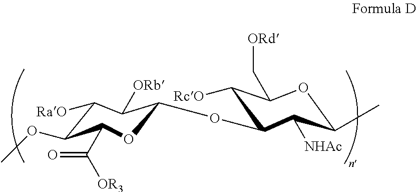
wherein
n′ is between 10 and 10,000,
R3 is H or Na, and
Ra′, Rb′, Re′ and Rd′ are each independently H or a unit of Formula C as defined in claim 41.

46. A method for crosslinking hyaluronic acid, comprising the following steps:
a) preparing a hyaluronic acid having at least one alkene unit grafted on at least one hydroxyl functional group of said hyaluronic acid by the preparation method according to one of claim 28,
b) reacting a compound including several thiol functional groups with the hyaluronic acid obtained in the preceding step,
c) recovering the crosslinked hyaluronic acid.

47. The method for crosslinking hyaluronic acid according to claim 46, wherein the compound including several thiol functional groups is selected from poly(ethylene glycol)dithiol and poly(ethylene)tetrathiol.

48. The method for crosslinking hyaluronic acid according to claim 46, wherein step b) includes irradiation with UV light.

49. The method for crosslinking hyaluronic acid according to one of claim 46, further including the hydration of hyaluronic acid to form a hydrogel.

50. A crosslinked hyaluronic acid that can be obtained by a method according to claim 46.

51. A hyaluronic acid hydrogel that can be obtained by the method according to claim 49.

52. A method for preparing crosslinked hyaluronic acid functionalized by at least one thioether unit, characterized in that it includes the preparation of a functionalized hyaluronic acid by the preparation method according to claim 37 and a method for crosslinking hyaluronic acid, comprising the following steps:
a) preparing a hyaluronic acid having at least one alkene unit grafted on at least one hydroxyl functional group of said hyaluronic acid by,
b) reacting an acid anhydride of the following Formula A: 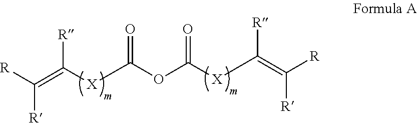
wherein:
m is an integer between 1 and 10,
X is a CR1R2 unit, wherein R1 and R2 are each independently a hydrogen atom, a halogen atom, a linear, branched or cyclic alkylene group having from 1 to 6 carbon atoms, an aryl group, or an arylalkyl group, and
R, R′ and R″ are each independently a hydrogen atom, a halogen atom, a linear, branched or cyclic alkyl radical having from 1 to 6 carbon atoms, an aryl group, or an arylalkyl group,
with at least one polysaccharide,
in a hydro-organic solvent comprised of water and a polar aprotic solvent or a polar protic solvent,
c) recovering the polysaccharide including a grafted alkene unit,
d) reacting a compound including several thiol functional groups with the hyaluronic acid obtained in the preceding step,
e) recovering the crosslinked hyaluronic acid.

53. A functionalized crosslinked hyaluronic acid that can be obtained by the method according to claim 52.

54. A controlled-release pharmaceutical or cosmetic composition, characterized in that it includes
a polysaccharide functionalized by at least one thioether unit grafted on a hydroxyl or amine functional group of said polysaccharide, said unit corresponding to the following Formula C: 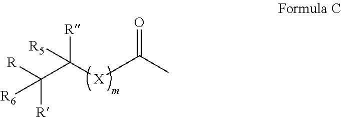
wherein
m is an integer between 1 and 10,
X is a CR1R2 unit, wherein R1 and R2 are each independently a hydrogen atom, a halogen atom, a linear, branched or cyclic alkylene group having from 1 to 6 carbon atoms, an aryl group, or an arylalkyl group,
R and R′ are each independently a hydrogen atom, a halogen atom, a linear, branched or cyclic alkyl radical having from 1 to 6 carbon atoms, an aryl group, or an arylalkyl group,
R5 or R6 is a hydrogen atom and the other is Rthio-S, Rthio being a group having at least 1 carbon atom,
a hyaluronic acid that can be obtained by a method comprising the following steps:
a) preparing a hyaluronic acid having at least one alkene unit grafted on at least one hydroxyl functional group of said hyaluronic acid by,
b) reacting an acid anhydride of the following Formula A: 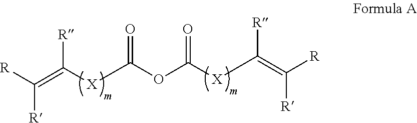
wherein:
m is an integer between 1 and 10,
X is a CR1R2 unit, wherein R1 and R2 are each independently a hydrogen atom, a halogen atom, a linear, branched or cyclic alkylene group having from 1 to 6 carbon atoms, an aryl group, or an arylalkyl group, and
R, R′ and R″ are each independently a hydrogen atom, a halogen atom, a linear, branched or cyclic alkyl radical having from 1 to 6 carbon atoms, an aryl group, or an arylalkyl group,
with at least one polysaccharide,
in a hydro-organic solvent comprised of water and a polar aprotic solvent or a polar protic solvent,
c) recovering the polysaccharide including a grafted alkene unit,
d) reacting a compound including several thiol functional groups with the hyaluronic acid obtained in the preceding step,
e) recovering the crosslinked hyaluronic acid; and/or
a hyaluronic acid hydrogel according to claim 51.

55. The method according to claim 28, wherein R, R′ and R″ are each a hydrogen atom.
